(19) United States
(12) Patent Application Publication
(10) Pub. No.: US 2014/0380222 A1
(43) Pub. Date: Dec. 25, 2014

(54) Complex Customizable Appointment Booking Workflows

(71) Applicant: TimeTrade Systems, Inc., Tewksbury, MA (US)

(72) Inventors: Peter Smith, Tewksbury, MA (US); John Loring, Tewksbury, MA (US); Brian Kelly, Tewksbury, MA (US)

(73) Assignee: TimeTrade Systems, Inc., Tewksbury`, MA (US)

(21) Appl. No.: 14/276,113

(22) Filed: May 13, 2014

Related U.S. Application Data
(60) Provisional application No. 61/837,674, filed on Jun. 21, 2013.

(51) Int. Cl. G06F 3/0484

(52) U.S. Cl. CPC G06F 3/04842
USPC 715/772

(57) ABSTRACT

A plurality of graphical user interface objects are displayed, wherein each object associated with a step in a sequence of user interface screens to be presented to a user in order to guide the user through an appointment scheduling process. Selections of the objects are received in order to build a customized appointment scheduling process. Information is stored representing the selections of the objects for the customized appointment scheduling process.

### CROSS REFERENCE TO RELATED APPLICATION

This application claims priority to U.S. Provisional Application No. 61/837,674 filed Jun. 21, 2013, the entirety of which is incorporated herein by reference.

### TECHNICAL FIELD

The present disclosure relates to web-based calendar/appointment systems.

### BACKGROUND

Meeting/appointment scheduling is a way in which a service provider can interact with its clients/customers. Online/web-based appointment scheduling has become a prevalent tool used to allow customers to book appointments with service providers. This also gives the service provider a chance to make a positive impression on its clients/customers.

The particular sequence of steps to be presented to a client/customer when scheduling an appointment can vary across different types of service providers. One sequence of steps is not necessarily applicable for every type of service provider.

### SUMMARY

Presented herein are techniques for a generic, dynamic process that is capable of presenting a complex booking workflow process to a user. The workflow contains any number of booking steps, each used to further assist the user with finding the most suitable appointment time for the user to book (reserve).

A plurality of graphical user interface objects are displayed, wherein each object is associated with a step in a sequence of user interface screens to be presented to a user in order to guide the user through an appointment scheduling process. Selections of the objects are received in order to build a customized appointment scheduling process. Information is stored representing the selections of the objects for the customized appointment scheduling process.

### BRIEF DESCRIPTION OF THE DRAWINGS

FIG. 1 is a block diagram of a system configured to allow for the creation of appointment booking workflows, according to an example embodiment.

FIG. 2 is a diagram illustrating an example of a function for creating a customizable appointment booking workflow, according to an example embodiment.

FIG. 3 is a diagram illustrating when an error condition occurs in building a customized appointment booking workflow/process using the steps setup in FIG. 2, according to an example embodiment.

FIG. 4 is a flow chart that depicts operations to build a customized appointment scheduling process, according to an example embodiment.

FIG. 5 illustrates an example user interface to build an appointment booking workflow using the steps depicted in FIG. 2, according to an example embodiment.

FIG. 6 is a flow chart depicting operations used to build an appointment booking workflow, according to an example embodiment.

FIG. 7 is a block diagram of a server configured to perform the techniques described herein, according to an example embodiment.

### DETAILED DESCRIPTION OF EXAMPLE EMBODIMENTS

Online/web-based appointment scheduling systems can greatly improve the efficiency of interaction between service providers and their clients/customers. The particular sequence of steps to be presented to a client/customer when scheduling an appointment can vary across different types of service providers. One sequence of steps is not necessarily appropriate for all types of service providers.

A booking step represents a single discrete choice for the user to make from a set of related values. For example, a “location” step would offer the user the opportunity to select from a number of physical locations (e.g., addresses) to which they could travel at the time of the appointment. Picking a location would allow the user to move to the next step in the sequence.

A booking step may or may not require a user selection to be made in order to proceed. For example, steps for picking locations, choosing an appointment time and choosing an appointment type would require the user to make a choice, and the workflow process enforces that. However steps that show instructions or ask for optional user information do not require the user to make a choice, allowing the user instead to proceed at will.

As the user proceeds with each step, the availability of matching appointment times is potentially reduced. For example, some locations might offer appointments from 9am to 5pm, but other locations may only offer the same type of appointments from 10am to 3pm.

The booking steps can be organized in a decision tree structure, allowing for certain user decisions to influence an automatic branch selection. For example, a user selecting “computer repair” for an “appointment type” step could be then directed to choose a physical building for their appointment. However if the user chooses “phone-based support” then the workflow would automatically skip the “location” step.

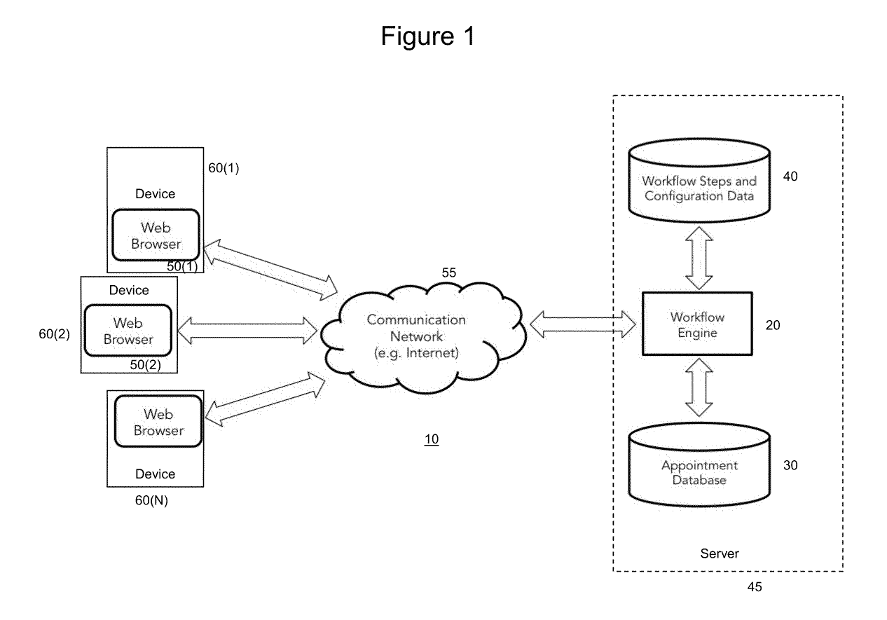

FIG. 1 shows an arrangement of a system in which the complex booking workflow process may be performed. The system, shown generally at reference numeral 10, includes a workflow engine 20, an appointment database 30 and a data repository 40 that stores workflow steps and configuration data. As described hereinafter, the workflow engine 20, appointment data 30 and data repository 40 may be managed/run by one or more applications on a server 45. The workflow engine 20 communicates with web browsers 50(1)-50(N) by way of a communication network, e.g., the Internet, shown at reference numeral 55. A different user is associated with each of the web browsers 50(1)-50(N). Moreover, the web browsers 50(1)-50(N) are running within user devices 60(1)-60(N), respectively. Data for appointments is stored in the appointment database 30. The operations of the server 45 may be performed by one or more applications running in a data center/cloud computing environment.

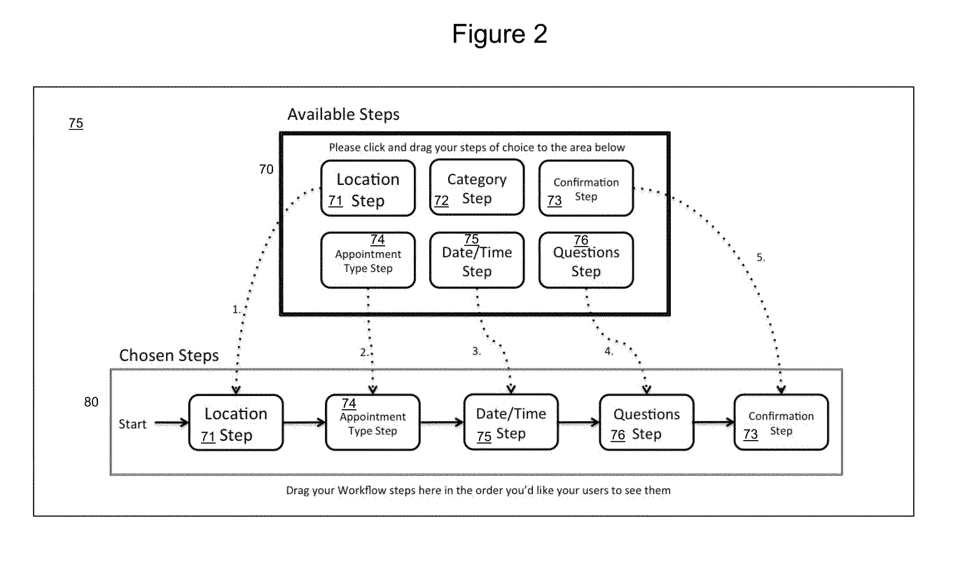

Reference is now made to FIG. 2. FIG. 2 shows the administrative setup function for creating such an appointment scheduling workflow/process from within an Internet web browser. In FIG. 2, graphical objects are shown at reference numeral 70 that represent the available workflow steps for an appointment scheduling workflow/process. The objects representing the steps chosen or selected by the user are shown at reference numeral 80. Each of the steps is represented by a corresponding one of a plurality of graphical user interface objects. The graphical user interface objects 70 representing the available workflow steps may be displayed in a first region of a display screen 75 and the selected objects 80 representing the selected steps may be displayed in a second region of the display screen 75. In this way, a user who wishes to design/customize an appointment scheduling workflow/process can drag-and-drop select ones of the objects 70 in a first region and move them to a second region of the display screen 75.

In this example, there are six steps available for a customizable appointment scheduling workflow, e.g., corresponding to objects 71-6. Object 71 represents a Location step, object 72 represents a Category step, object 73 represents a Confirmation, object 74 represents an Appointment Type step, object 75 represents a Date/Time and object 76 is Questions step. The Location step allows a client/customer to select a particular venue or location of a service provider, when the service provider has multiple locations. The Appointment Type step allows a client/customer to select the nature of the service for which an appointment is sought. The Category step allows a client/customer to help a user find the right group of appointment types from which to choose. A top-level category of services might be “Car Service” and “Sales”, but if a user chooses the Category of “Car Service”, when the user gets to the appointment type step, the system would offer the user choices of “Oil Change”, “Tire Rotation”, etc. The Date/Time step allows a customer to select the particular day/time for the appointment. The Questions step is provided to allow the service provider to ask certain questions that may be relevant to the appointment that is being scheduled by the workflow.

A user uses a “drag-and-drop” model to select a predetermined number of objects (corresponding to steps), such as 5 objects, for insertion into an ordered flow or sequence. In this example, the user selected objects 71, 74, 75, 76 and 73, in that order.

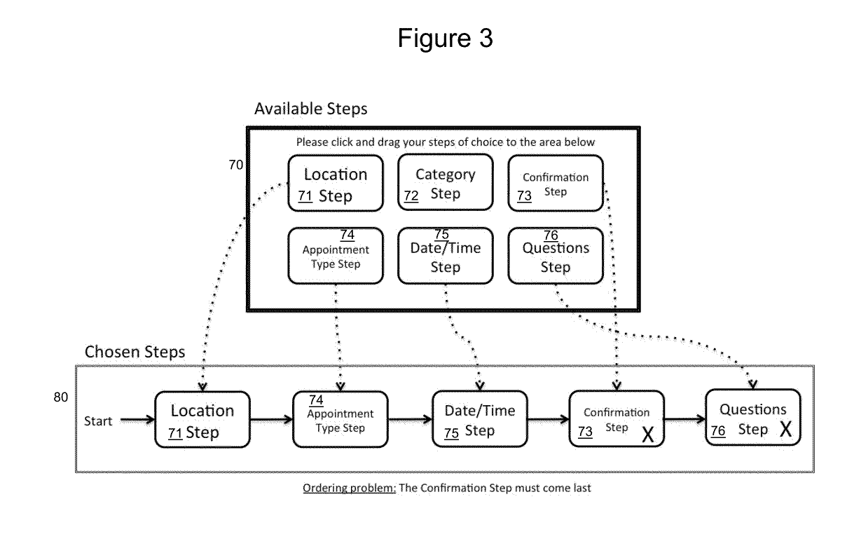

FIG. 3 depicts an example of a situation when the workflow engine detects an error in a user's selected ordering of steps. For example, the Confirmation Step 76 has been configured/designated to always occur last in appointment scheduling sequences. Therefore, when a user attempts to make it the penultimate step, the workflow engine flags it as an error.

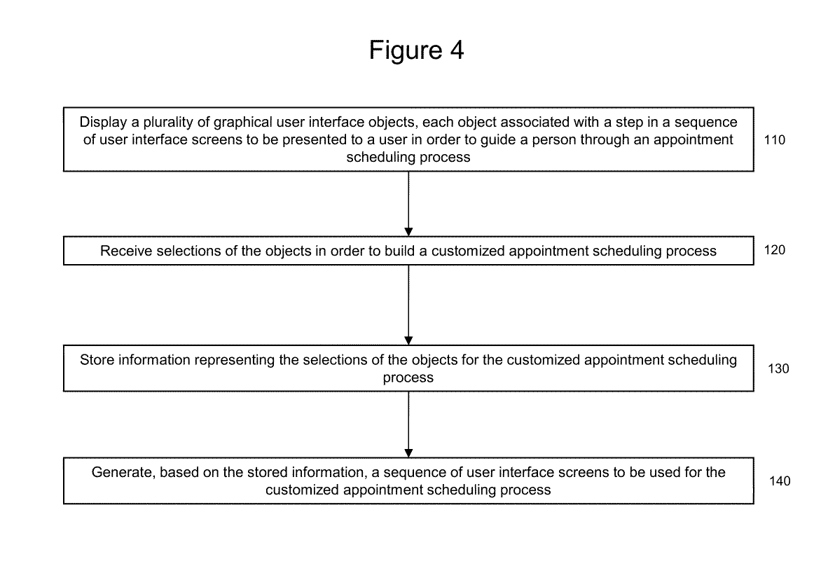

FIG. 4 illustrates a flow chart for a method 100 of building a customized appointment scheduling process/workflow. At 110, a plurality of graphical user interface objects are displayed. Each object is associated with a step in a sequence of user interface screens to be presented to a user in order to guide the user through an appointment scheduling process. This is shown by the objects representing available steps at reference numeral 70 in FIGS. 2 and 3. At 120, selections of objects are received in order to build a customized appointment scheduling process. At 130, information is stored representing the selections of the objects for the customized appointment scheduling process. At 140, based on the stored information at 130, a sequence is generated of user interface screens to be used for the customized appointment scheduling process.

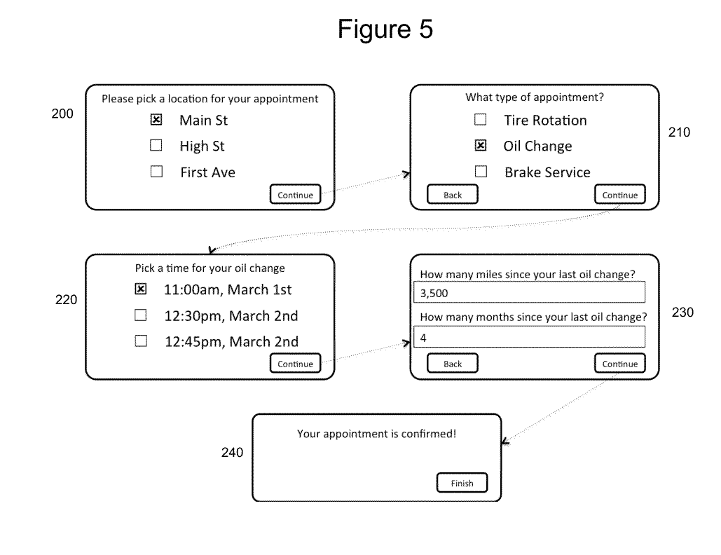

FIG. 5 shows an example user experience as a client/customer proceeds through an appointment scheduling workflow after it has been designed/customized according to the techniques described above in connection with FIGS. 1-4. In this example, the service provider with which an appointment is to be scheduled is an auto maintenance service provider. At 200, a user interface screen is presented for the location selection step 200, in which a client/customer is presented with location options for the appointment. The service provider may have multiple locations/sites where the service appointment could be accepted. At 210, a user interface screen is presented for options to select the type of appointment, that is, the type(s) of service(s) to be provided during the appointment. At 220, a user interface screen is presented with the day and time selection options for the appointment. At 230, a user interface screen is presented with one or more questions that are relevant to the appointment, and at 240, confirmation that the appointment has been made is presented to the client/customer. The client/customer progresses through the flow, with his/her choice at each step potentially reducing the available times to be offered in the date/time step.

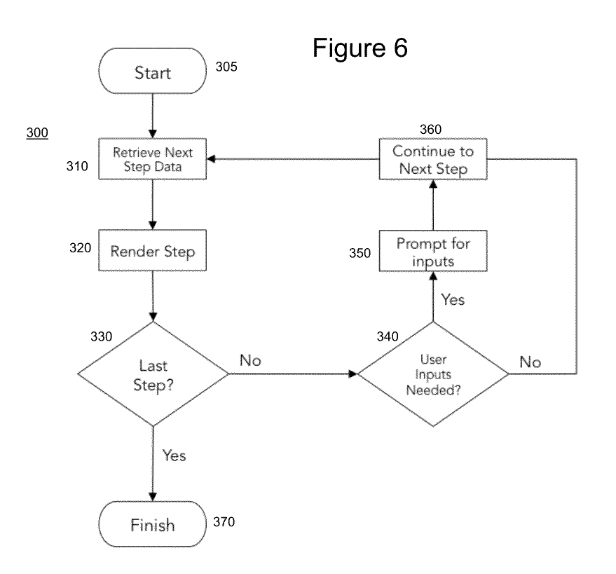

Reference is now made to FIG. 6 for a description of a flow chart 300 depicting the operations performed for the customizable appointment booking workflow schemes presented herein. The process starts at 305, and at 310, data for the next (or the first, if the first time through) step in a given work flow is retrieved. At 320, the step is render. At 330, it is determined whether it is the last step, and if not, the process continues to 340. At 340, it is determined whether user inputs are needed for the current step. If so, at 350, prompts for user inputs are made to receive the user inputs. At 360, continuation is made to the next step. If no inputs are needed at 340, that step 350 is not performed. This procedure continues until it is determined in 230 that the last step has been reached, and then the process ends at 370.

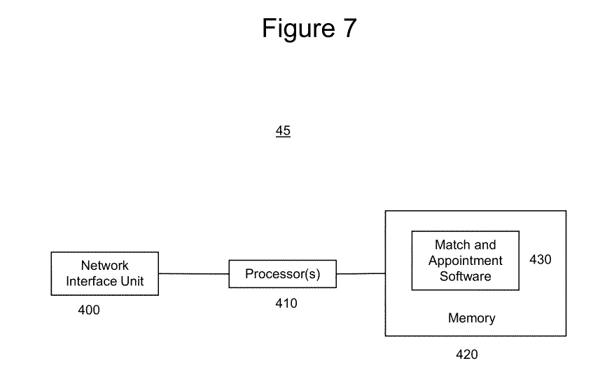

Turning to FIG. 7, an example block diagram is shown for server 45 on which the work flow engine 20 and other functions may be running The server 45 includes a network interface unit 400 configured to enable network communications to send messages to and receive messages from, e.g., web browsers, of user devices. One or more processors 410 are provided that execute software stored in memory 420. The processor(s) 410 is, for example, a microprocessor or microcontroller. To this end, the memory 420 stores instructions for work flow engine software 430. When the one or more processors 410 execute the work flow engine software 430, the server 45 performs the operations described herein in connection with FIGS. 1-6.

Memory 420 may comprise read only memory (ROM), random access memory (RAM), magnetic disk storage media devices, optical storage media devices, flash memory devices, electrical, optical, or other physical/tangible memory storage devices. Thus, in general, the memory 420 may comprise one or more tangible (non-transitory) computer readable storage media (e.g., a memory device) encoded with software comprising computer executable instructions and when the software is executed (by the processor(s) 410) it is operable to perform the operations described herein.

In summary, a method is provided comprising: displaying a plurality of graphical user interface objects, each object associated with a step in a sequence of user interface screens to be presented to a user in order to guide the user through an appointment scheduling process; receiving selections of the objects in order to build a customized appointment scheduling process; and storing information representing the selections of the objects for the customized appointment scheduling process.

An apparatus is provided comprising a network interface unit configured send and receive communications over a network; a memory; at least one processor coupled to the network interface unit and to the memory, and configured to: generate display data for displaying a plurality of graphical user interface objects, each object associated with a step in a sequence of user interface screens to be presented to a user in order to guide the user through an appointment scheduling process; receive selections of the objects in order to build a customized appointment scheduling process; and store in the memory information representing the selections of the objects for the customized appointment scheduling process.

Still further, a computer readable storage media is provided that stores or is encoded with instructions that, when executed by a processor, cause the processor to: generate display data for displaying a plurality of graphical user interface objects, each object associated with a step associated with sequence of user interface screens to be presented to a user in order to guide the user through an appointment scheduling process; receive selections of the objects in order to build a customized appointment scheduling process; and store information representing the selections of the objects for the customized appointment scheduling process.

The above description is intended by way of example only.

What is claimed is:

1. A method comprising:
displaying a plurality of graphical user interface objects, each object associated with a step in a sequence of user interface screens to be presented to a user in order to guide the user through an appointment scheduling process;
receiving selections of the objects in order to build a customized appointment scheduling process; and
storing information representing the selections of the objects for the customized appointment scheduling process.

2. The method of claim 1, wherein receiving comprises receiving input for one or more parameters associated with one or more of the steps of the customized appointment scheduling process.

3. The method of claim 1, further comprising receiving an indication of a sequence of the steps for the customized appointment scheduling process.

4. The method of claim 3, wherein receiving the indication of the sequence is based on an arrangement of the objects within a region of a display screen.

5. The method of claim 3, further comprising analyzing the sequence of the steps selected and generating a notification if there is a logical error associated with an order of one or more of the steps in the sequence.

6. The method of claim 1, wherein displaying comprises displaying in a first region of a display screen the plurality of graphical user interface objects, each of which represents an available step in an appointment scheduling process, and wherein receiving comprises receiving drag-and-drop movements of objects from the first region into a second region of the display screen, wherein a linear order of placement of objects in the second region represents a sequence of steps in the customized appointment scheduling process.

7. The method of claim 1, further comprising generating, based on the stored information, a sequence of user interface screens to be used for the customized appointment scheduling process.

8. The method of claim 7, further comprising receiving input for each of the user interface screens of the customized appointment scheduling process.

9. The method of claim 8, further comprising determining content to be presented in a next user interface screen of the customized appointment scheduling process based on content received in a current user interface screen of the customized appointment scheduling process.

10. An apparatus comprising:
a network interface unit configured send and receive communications over a network;
a memory;
at least one processor coupled to the network interface unit and to the memory, and configured to:
generate display data for displaying a plurality of graphical user interface objects, each object associated with a step in a sequence of user interface screens to be presented to a user in order to guide the user through an appointment scheduling process;
receive selections of the objects in order to build a customized appointment scheduling process; and
store in the memory information representing the selections of the objects for the customized appointment scheduling process.

11. The apparatus of claim 10, wherein the processor is configured to receive input for one or more parameters associated with one or more of the steps of the customized appointment scheduling process.

12. The apparatus of claim 10, wherein the processor is configured to receive an indication of a sequence of the steps for the customized appointment scheduling process.

13. The apparatus of claim 12, wherein the processor is configured to receive the indication of the sequence based on an arrangement of the objects within a region of a display screen.

14. The apparatus of claim 13, wherein the processor is further configured to analyze the sequence of the steps selected and generate a notification if there is a logical error associated with an order of one or more of the steps in the sequence.

15. The apparatus of claim 13, wherein the processor is configured to generate the display data to display in a first region of a display screen the plurality of graphical user interface objects, each of which represents an available step in an appointment scheduling process, and to respond to drag-and-drop movements of objects from the first region into a second region of the display screen, wherein a linear order of placement of objects in the second region represents a sequence of steps in the customized appointment scheduling process.

16. The apparatus of claim 10, wherein the processor is configured to generate, based on the stored information, a sequence of user interface screens to be used for the customized appointment scheduling process.

17. The apparatus of claim 16, wherein the processor is configured to receive input for each of the user interface screens of the customized appointment scheduling process, and to determine content to be presented in a next user interface screen of the customized appointment scheduling process based on content received in a current user interface screen of the customized appointment scheduling process.

18. A computer readable storage media storing instructions that, when executed by a processor, cause the processor to:
generate display data for displaying a plurality of graphical user interface objects, each object associated with a step associated with sequence of user interface screens to be presented to a user in order to guide the user through an appointment scheduling process;
receive selections of the objects in order to build a customized appointment scheduling process; and
store information representing the selections of the objects for the customized appointment scheduling process.

19. The computer readable storage media of claim 18, further comprising instructions that cause the processor to receive input for one or more parameters associated with one or more of the steps of the customized appointment scheduling process, and receive an indication of a sequence of the steps for the customized appointment scheduling process.

20. The computer readable storage media of claim 18, further comprising instructions that, when executed by the processor, cause the processor to:
generate, based on the stored information, a sequence of user interface screens to be used for the customized appointment scheduling process; and
receive input for each of the user interface screens of the customized appointment scheduling process; and
determine content to be presented in a next user interface screen of the customized appointment scheduling process based on content received in a current user interface screen of the customized appointment scheduling process.
